(19) United States
(12) Patent Application Publication
(10) Pub. No.: US 2010/0218786 A1
(43) Pub. Date: Sep. 2, 2010

(54) CLEANING METHOD OF PLASMA PROCESSING APPARATUS AND STORAGE MEDIUM

(75) Inventors: Masahiro Ogasawara, Yamanashi (JP); Kenji Tago, Sagamihara (JP); Junichi Sasaki, Yamanashi (JP); Mafumi Sato, Yamanashi (JP)

Correspondence Address: PEARNE & GORDON LLP, 1801 EAST 9TH STREET, SUITE 1200, CLEVELAND, OH, 44114-3108, US

(73) Assignee: TOKYO ELECTRON LIMITED, Tokyo (JP)

(21) Appl. No.: 12/711,602

(22) Filed: Feb. 24, 2010

Related U.S. Application Data
(60) Provisional application No. 61/224,130, filed on Jul. 9, 2009.

(30) Foreign Application Priority Data
Feb. 27, 2009 (JP) 2009-045176

(51) Int. Cl. B08B 7/00; G05D 11/02

(52) U.S. Cl. 134/1.1; 700/285

(57) ABSTRACT

Provided are a storage medium and a cleaning method of a plasma processing apparatus capable of more securely removing a deposit and preventing occurrence of any problems caused by a remaining deposit as compared to the conventional method. A cleaning gas which contains an oxygen gas and a nitrogen gas and has a ratio of “nitrogen gas flow rate/(nitrogen gas flow rate+oxygen gas flow rate)” in a range from about 0.05 to about 0.5 is introduced into a processing chamber when a substrate is not mounted on a mounting table, and, then, the inside of the processing chamber is cleaned by applying a high frequency power between the mounting table and an upper electrode and exciting the cleaning gas into plasma.

### CROSS-REFERENCE TO RELATED APPLICATION

This application claims the benefit of Japanese Patent Application No. 2009-045176 filed on Feb. 27, 2009 and U.S. Provisional Application Ser. No. 61/224,130 filed on Jul. 9, 2009, the entire disclosures of which are incorporated herein by reference.

### FIELD OF THE INVENTION

The present disclosure relates to a storage medium and a cleaning method of a plasma processing apparatus which performs a plasma process on a substrate.

### BACKGROUND OF THE INVENTION

Conventionally employed in a manufacturing process of a semiconductor device is a plasma etching apparatus that performs a plasma process on a substrate such as a semiconductor wafer or a glass substrate for liquid crystal display within a processing chamber, by generating plasma of a processing gas in the processing chamber.

As a plasma processing apparatus, there has been known, for example, a plasma etching apparatus that includes a mounting table (lower electrode) for mounting thereon a substrate and an upper electrode positioned to face the mounting table within a processing chamber, and is capable of generating plasma by applying a high frequency power between the mounting table and the upper electrode.

In the plasma etching apparatus, when plasma etching is performed, a reaction by-product is deposited inside the processing chamber, and thus, it is necessary to clean the inside of the processing chamber. As a cleaning method of the plasma etching apparatus, there has been known a technique in which a dummy substrate is mounted on the mounting table, a cleaning gas is introduced into the processing chamber, and plasma of the cleaning gas is generated, so that the inside of the processing chamber is cleaned by the plasma.

The reason for using the dummy substrate at the time of cleaning the processing chamber is to prevent, e.g., an electrostatic chuck for attracting and holding the substrate mounted on the mounting table in the processing chamber from being exposed to the plasma and damaged by the plasma. There has also been known a so-called waferless dry cleaning for cleaning the inside of the processing chamber without using the dummy substrate unlike the above-described technique. In the waferless dry cleaning, an oxygen single gas is used as the cleaning gas and oxygen plasma is used for performing a cleaning process in order to prevent the electrostatic chuck or the like from being damaged by the exposure of the plasma (see, for example, Patent document 1).

Further, as a technique of sequentially etching a substrate in the same processing chamber with multiple plasma species, there has been known a cleaning method in which the processing chamber is cleaned by a mixed gas as the cleaning gas containing a nitrogen gas having a flow rate of about 100 to about 400 mL/min and an oxygen gas having a flow rate of about 5 to about 15 mL/min while a target substrate is mounted on a mounting table (see, for example, Patent Document 2). However, this cleaning method is carried out while the substrate is mounted on the mounting table, so that it is not a waferless dry cleaning and also not relevant to the waferless dry cleaning.

Patent Document 1: Japanese Laid-open Publication No. 2007-207842

Patent Document 2: Japanese Patent Laid-open Publication No. 2005-353698

### BRIEF SUMMARY OF THE INVENTION

As described above, conventionally, when waferless dry cleaning is carried out without using a dummy substrate in a plasma etching apparatus, an oxygen gas has been used as a cleaning gas. However, according to researches of the present inventors, in case of using the oxygen gas as the cleaning gas, a deposit deposited on a peripheral portion of an electrostatic chuck on a mounting table is not removed and remains. Therefore, if the plasma etching apparatus is continuously operated while the deposit remains, a chucking error, i.e., a state where a semiconductor wafer is not normally chucked to the electrostatic chuck, may occur due to the deposit.

In view of the foregoing, the present disclosure provides a storage medium and a cleaning method of a plasma processing apparatus capable of more securely removing a deposit and preventing occurrence of any problems caused by a remaining deposit as compared to the conventional method.

In accordance with an aspect of the present disclosure, there is provided a cleaning method for cleaning an inside of a processing chamber of a plasma processing apparatus including: a processing chamber; a mounting table installed in the processing chamber and configured to mount a substrate; and an upper electrode that is positioned above the mounting table to face toward the mounting table within the processing chamber. The cleaning method includes introducing a cleaning gas into the processing chamber when the substrate is not mounted on the mounting table and cleaning the inside of the processing chamber by applying a high frequency power between the mounting table and the upper electrode and exciting the cleaning gas into plasma. Here, the cleaning gas contains an oxygen gas and a nitrogen gas and has a ratio of a nitrogen gas flow rate to a sum of an oxygen gas flow rate and the nitrogen gas flow rate (nitrogen gas flow rate/(nitrogen gas flow rate+oxygen gas flow rate)) in a range from about 0.05 to about 0.5.

In the cleaning method of the plasma processing apparatus, the ratio of the nitrogen gas flow rate to the sum of the oxygen gas flow rate and the nitrogen gas flow rate in the cleaning gas (nitrogen gas flow rate/(nitrogen gas flow rate+oxygen gas flow rate)) may be in a range from about 0.2 to about 0.4.

In the cleaning method of the plasma processing apparatus, the sum of the oxygen gas flow rate and the nitrogen gas flow rate in the cleaning gas may be in a range from about 100 to about 800 sccm.

In the cleaning method of the plasma processing apparatus, the high frequency power may be applied to the upper electrode but not to the mounting table.

In accordance with another aspect of the present disclosure, there is provided a storage medium storing therein a program for controlling a plasma processing apparatus including: a processing chamber; a mounting table installed in the processing chamber and configured to mount a substrate; and an upper electrode that is positioned above the mounting table to face toward the mounting table within the processing chamber. The program is executed to introduce a cleaning gas into the processing chamber when the substrate is not mounted on the mounting table and clean the inside of the processing chamber by applying a high frequency power between the mounting table and the upper electrode and exciting the cleaning gas into plasma. Here, the cleaning gas contains an oxygen gas and a nitrogen gas and has a ratio of a nitrogen gas flow rate to a sum of an oxygen gas flow rate and the nitrogen gas flow rate (nitrogen gas flow rate/(nitrogen gas flow rate+oxygen gas flow rate)) in a range from about 0.05 to about 0.5.

In accordance with the present disclosure, there can be provided a storage medium and a cleaning method of a plasma processing apparatus capable of more securely removing a deposit, thereby preventing occurrence of any problems caused by a remaining deposit.

### BRIEF DESCRIPTION OF THE DRAWINGS

The disclosure may best be understood by reference to the following description taken in conjunction with the following figures:

FIG. 1 illustrates a configuration of a plasma etching apparatus serving as a plasma processing apparatus in accordance with an embodiment of the present disclosure; and

FIG. 2 is a view showing an analysis result on a composition of a deposit.

### DETAILED DESCRIPTION OF THE INVENTION

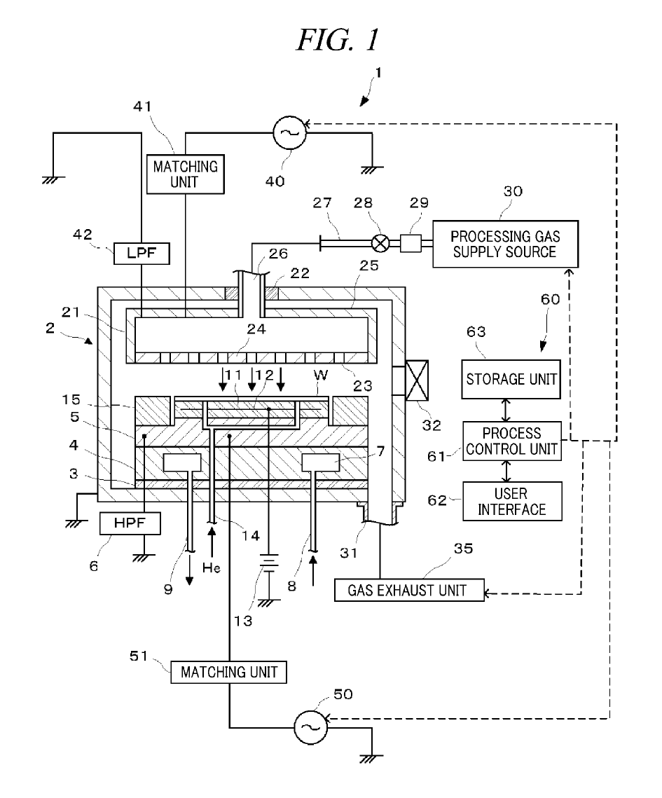

Hereinafter, embodiments of the present invention will be described in detail with reference to the accompanying drawings. FIG. 1 illustrates a configuration of a plasma etching apparatus serving as a plasma processing apparatus in accordance with the present disclosure.

A plasma etching apparatus 1 is configured as a capacitively coupled parallel plate type etching apparatus in which electrode plates face each other in parallel and a power supply for generating plasma is connected thereto.

The plasma etching apparatus 1 includes a cylindrical processing chamber (processing vessel) 2 made of an aluminum whose surface is anodically oxidized, and the processing chamber 2 is grounded. Further, a substantially cylindrical susceptor support 4 for mounting thereon a target object such as a semiconductor wafer W is installed in a bottom portion of the processing chamber 2, with an insulating plate 3 made of, e.g., ceramic therebetween. Furthermore, a susceptor (mounting table) 5 serving as a lower electrode is installed on the susceptor support 4. The susceptor 5 is connected to a high pass filter (HPF) 6.

Inside the susceptor support 4, a coolant reservoir 7 is provided. A coolant is introduced into the coolant reservoir 7 through a coolant introducing line 8 and circulated therein, and discharged through a coolant discharge line 9. A cold heat of the coolant is thermally transferred to the semiconductor wafer W via the susceptor 5, and thus the temperature of the semiconductor wafer W is controlled as desired.

An upper central portion of the susceptor 5 is formed in a protruded circular plate shape on which an electrostatic chuck 11 having the substantially same shape as the semiconductor wafer W is installed. The electrostatic chuck 11 includes an electrode 12 within an insulating member. Further, a DC voltage of, e.g., 1.5 kV is applied to the electrostatic chuck 11 from a DC power supply 13 connected to the electrode 12, so that the semiconductor wafer W is electrostactically attracted by, e.g., Coulomb force.

A gas passage 14 for supplying a heat transfer medium (for example, a He gas) to a rear surface of the semiconductor wafer W is formed through the insulating plate 3, the susceptor support 4, the susceptor 5, and the electrostatic chuck 11. Through the heat transfer medium, a cold heat of the susceptor 5 is transferred to the semiconductor wafer W to maintain the temperature of the semiconductor wafer W at a predetermined level.

An annular focus ring 15 is installed at an upper peripheral portion of the susceptor 5 so as to surround the semiconductor wafer W mounted on the electrostatic chuck 11. This focus ring 15 is made of a conductive material such as silicon and improves etching uniformity.

Above the susceptor 5, there is installed an upper electrode 21 facing the susceptor 5 in parallel. The upper electrode 21 is supported at an upper portion of the processing chamber 2 via an insulating member 22. The upper electrode 21 is composed of an electrode plate 24 and an electrode support 25 made of a conductive material, for supporting the electrode plate 24. The electrode plate 24 is made of a semiconductor or a conductor, such as Si or SiC and has a plurality of discharge holes 23. The electrode plate 24 faces the susceptor 5.

There is installed a gas introduction port 26 at the center of the electrode support 25 of the upper electrode 21, and the gas introduction port 26 is connected to a gas supply pipe 27. Further, the gas supply pipe 27 is connected to a processing gas supply source 30 via a valve 28 and a mass flow controller 29. The processing gas supply source 30 supplies an etching gas used for plasma etching and a cleaning gas used for waferless dry cleaning.

There is installed an exhaust pipe 31 at a bottom portion of the processing chamber 2, and the exhaust pipe 31 is connected to a gas exhaust unit 35. The gas exhaust unit 35 includes a vacuum pump such as a turbo-molecular pump and is configured to evacuate the inside of the processing chamber 2 to be in a predetermined depressurized atmosphere, i.e., to a predetermined pressure of, e.g., about 1 Pa or less. Further, a gate valve 32 is provided at a side wall of the processing chamber 2, and with the gate valve 32 open, the semiconductor wafer W is transferred to/from an adjacent load-lock chamber (not illustrated).

The upper electrode 21 is connected to a first high frequency power supply 40, and a matching unit 41 is provided on a power supply line thereof. Further, the upper electrode 21 is connected to a low pass filter (LPF) 42. The first high frequency power supply 40 has a frequency ranging from about 27 to about 150 MHz. Accordingly, it is possible to generate high-density plasma in a desirable dissociated state within the processing chamber 2 by applying such a high frequency.

The susceptor 5 serving as a lower electrode is connected to a second high frequency power supply 50, and a matching unit 51 is provided on a power supply line thereof. The second high frequency power supply 50 has a frequency in a range lower than the frequency of the first high frequency power supply 40. By applying the frequency in such a range, it is possible to provide an appropriate ion action without damaging the semiconductor wafer W serving as a target substrate. It is desirable for the second high frequency power supply 50 to have a frequency ranging from about 1 to about 20 MHz, for example.

As illustrated in FIG. 1, the whole operations of the above-described plasma etching apparatus 1 are controlled by a controller 60. The controller 60 includes a process control unit 61 having a CPU, for controlling each component of the plasma etching apparatus 1, a user interface 62, and a storage unit 63.

The user interface 62 includes a keyboard through which a process manager inputs commands to manage the plasma etching apparatus 1 and a display for visually showing an operation status of the plasma etching apparatus 1.

The storage unit 63 stores a control program (software) for executing various processes performed in the plasma etching apparatus 1 under the control of the process control unit 61; or recipes that store processing condition data. If necessary, a required process is performed in the plasma etching apparatus 1 under the control of the process control unit 61 by retrieving a necessary recipe from the storage unit 63 in response to an instruction from the user interface 62 and executing the recipe by the process control unit 61. Further, the control program or the recipe of the processing condition data which is stored in a computer-readable storage medium (for example, a hard disc, a CD, a flexible disc, a semiconductor memory or the like) may be used. The control program or the recipe can be also used online by receiving it from another apparatus through, for example, a dedicated line whenever necessary.

In case that the semiconductor wafer W is plasma etched by the above-described plasma etching apparatus 1, the gate valve 32 is opened, and, then, the semiconductor wafer W is loaded into the processing chamber 2 from a non-illustrated load-lock chamber and mounted on the electrostatic chuck 11. Then, a DC voltage is applied from the DC power supply 13, so that the semiconductor wafer W is electrostactically attracted onto the electrostatic chuck 11. Subsequently, the gate valve 32 is closed and the inside of the processing chamber 2 is evacuated to a predetermined vacuum level by the gas exhaust unit 35.

Thereafter, the valve 28 is opened, and a predetermined etching gas is introduced from the processing gas supply source 30 into a hollow region of the upper electrode 21 through the processing gas supply pipe 27 and the gas introduction port 26 while its flow rate is controlled by the mass flow controller 29. Then, the gas is uniformly discharged toward the semiconductor wafer W through the discharge holes 23 of the electrode plate 24 as indicated by the arrow in FIG. 1.

The internal pressure of the processing chamber 2 is maintained at a predetermined level. Then, a high frequency power with a predetermined frequency is applied from the first high frequency power supply 40 to the upper electrode 21. Accordingly, a high frequency electric field is generated between the upper electrode 21 and the susceptor 5 serving as the lower electrode, and thus the etching gas is dissociated and excited into plasma.

Meanwhile, a high frequency power with a lower frequency than the above-described frequency of the first high frequency power supply 40 is applied from the second high frequency power supply 50 to the susceptor 5 serving as the lower electrode. Accordingly, ions in the plasma are attracted toward the susceptor 5 and etching anisotropy is increased by ion-assist.

Further, when the predetermined plasma etching process is ended, the supplies of the high frequency power and the processing gas are stopped. In reverse order to the order described above, the semiconductor wafer W is unloaded from the processing chamber 2. After the semiconductor wafer W is unloaded from the processing chamber 2 as described above, a predetermined cleaning gas is supplied into the processing chamber 2. While the inside of the processing chamber 2 is maintained at a predetermined pressure level, plasma of the cleaning gas is generated, and, thus, waferless dry cleaning is performed within the processing chamber 2.

The plasma etching apparatus 1 configured as stated above was run for about 20 hours by repeatedly performing a cycle, in which a SiO₂ film is plasma etched with an etching gas of C₄F₈/C₃F₈/Ar/O₂ (total flow rate of about 790 sccm), a pressure of about 2.66 Pa (20 mTorr), and a high frequency power (upper side power/lower side power=about 1200/4200 W) for about 200 seconds, and then the semiconductor wafer is unloaded from the processing chamber 2, and then waferless dry cleaning is performed.

In an experiment example, the waferless dry cleaning was performed for about 20 seconds within the processing chamber 2 by using O₂/N₂ gas having a flow rate of about 270/130 sccm as a cleaning gas at a pressure of about 13.3 Pa (100 mTorr), and a high frequency power (upper side power/lower side power=about 2000/0 W).

After about 20 hours running in the above-described experiment example, the processing chamber 2 was opened and the inside thereof was observed by the naked eyes. As a result, it was found out that the inside of the processing chamber 2 as well as a peripheral portion of the electrostatic chuck 11 is kept in a state where there is no residue of a deposit. Subsequently, after the running time of about 100 hours, the inside of the processing chamber 2 was also observed and, consequently, it was found out that the inside of the processing chamber 2 as well as a peripheral portion of the electrostatic chuck 11 is kept in a state where there is no residue of the deposit.

In the above-described experiment example, during the waferless dry cleaning, a surface of the electrostatic chuck 11 is exposed to the plasma and readily damaged by the plasma. For this reason, it is desirable for the first high frequency power supply 40 to apply a high frequency power to the upper electrode 21, but for the second high frequency power supply 50 not to apply a high frequency power to the susceptor 5. Further, as the power applied from the first high frequency power supply 40 increases, an etching rate of the deposit becomes higher during the waferless dry cleaning. Accordingly, it is desirable that the applied power is in the range from about 1500 W to about 2500 W. Furthermore, considering the damage to the surface of the electrostatic chuck 11 by the plasma, the applied power is more desirably about 2000 W in the above-described experiment example.

Moreover, in the above-described experiment example, if the total flow rate of the cleaning gas is too high, the etching rate of the deposit tends to be decreased during the waferless dry cleaning. For this reason, the total flow rate is desirably in the range from about 100 sccm to about 800 sccm and more desirably about 400 sccm in the above-described experiment example.

Further, if the N₂ gas of too small quantity is added to the cleaning gas, an effect of addition of the N₂ gas is not sufficient. In contrast, if the N₂ gas of too large quantity is added thereto, the etching rate of the deposit tends to be decreased during the waferless dry cleaning. For this reason, a ratio of a N₂ gas flow rate to a sum of a O₂ gas flow rate and the N₂ gas flow rate (N₂ gas flow rate/(N₂ gas flow rate+O₂ gas flow rate)) is desirably in the range from about 0.05 to about 0.5 and more desirably in the range from about 0.2 to about 0.4. In the above-described experiment example, the ratio of a N₂ gas flow rate to a sum of a O₂ gas flow rate and the N₂ gas flow rate is set to about 130/400, i.e., about 0.33. Since much of the deposit is typically deposited on the peripheral portion of the electrostatic chuck but not much is deposited on a central portion of the electrostatic chuck, it is desirable to adjust a condition such that the etching rate on the peripheral portion is higher than that on the central portion during the waferless dry cleaning. Therefore, it is possible to minimize damage to the electrostatic chuck.

In the above-described experiment example, etching rates of a photoresist and a SiO₂ film and uniformity of etching rates in a surface were measured after running times of 0 hour (initial state), 60 hours, and 100 hours, respectively as follows:
Running time of 0 hour
   Etching rate of photoresist: 114.8 nm/min±6.6%
   Etching rate of SiO₂ film: 560.3 nm/min±8.1%
Running time of 60 hours
   Etching rate of photoresist: 114.5 nm/min±6.5%
   Etching rate of SiO₂ film: 556.1 nm/min±6.5%
Running time of 100 hours
   Etching rate of photoresist: 113.9 nm/min±8.3%
   Etching rate of SiO₂ film: 555.0 nm/min±6.8%

It was found out that even after the running times of 60 hours and 100 hours, it is possible to perform a stable etching process with not much difference from the initial state, and the waferless dry cleaning in the above-described experiment example does not have a bad influence on the etching process.

Since the SiO₂ film is plasma etched using a CF-based gas in the above-described experiment example, a CF-based by-product is deposited. It is presumed that the nitrogen gas of the cleaning gas functions to take out fluorine from the CF-based by-product, so that the by-product becomes carbon-rich and easily reacts with oxygen plasma, and, thus, it is removed.

As a first comparative example, the plasma etching apparatus 1 was run for about 20 hours in the same manner as the above-described experiment example by repeatedly performing a cycle, in which a waferless dry cleaning process was changed from that of the experiment example and it was performed for about 20 seconds using O₂ gas (single gas) having a flow rate of about 600 sccm as a cleaning gas at a pressure of about 26.6 Pa (200 mTorr) and a high frequency power (upper side power/lower side power=1000/0 W). As a result of observation of the processing chamber 2 after the running time of 20 hours, it was found that a large quantity of a deposit remained in the processing chamber 2 as well as the peripheral portion of the electrostatic chuck 11.

As a second comparative example, the plasma etching apparatus 1 was run for about 20 hours in the same manner as the above-described experiment example by repeatedly performing a cycle, in which a waferless dry cleaning process was changed from that of the experiment example and it was performed for about 20 seconds using an O₂ gas (single gas) having a flow rate of about 400 sccm as a cleaning gas at a pressure of about 13.3 Pa (100 mTorr) and a high frequency power (upper side power/lower side power=2000/0 W). As a result of observation of the processing chamber 2 after the running time of about 20 hours, although a smaller quantity of a deposit remained in the processing chamber 2 as compared to the first comparative example, it was found that a deposit remained on the peripheral portion of the electrostatic chuck 11. Further, although processing conditions of the second comparative example was set so as to obtain the best cleaning result by modifying a flow rate of a cleaning gas, a pressure, and a high frequency power in case of using the O₂ gas (single gas) as the cleaning gas, it was found out that its cleaning result was clearly inferior to that of the above-described experiment example.

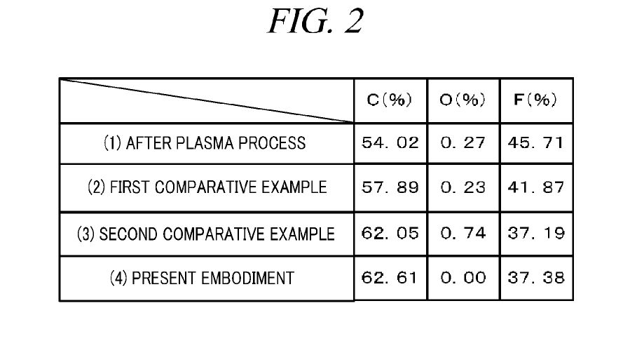

In order to verify the above-described cleaning model, an analysis on a composition of a deposit has been made. A result thereof is shown in FIG. 2. As compared to cases (1) after a plasma process and (2) first comparative example, it can be seen from the result that the amount of fluorine is decreased and the amount of carbon is increased in cases (3) second comparative example and (4) experiment example. Further, whether a deposit contains a residue (O) or not is a difference between (3) second comparative example (O₂ single gas) and (4) experiment example (O₂/N₂). In the case (4), a cleaning gas contains a nitrogen gas, so that a C—O—F bonding, which is a strong bonding existing in the case (3), does not exist. Therefore, it is deemed that a better cleaning result can be obtained as compared to a case of using the O₂ single gas.

As described above, in accordance with the present embodiment, it is possible to more securely remove a deposit, and to prevent occurrence of any problems caused by a remaining deposit as compared to the conventional case. Further, the above description of the present invention is provided for the purpose of illustration, and it would be understood by those skilled in the art that various changes and modifications may be made without changing technical conception and essential features of the present invention.

What is claimed is:

1. A cleaning method for cleaning an inside of a processing chamber of a plasma processing apparatus including: a processing chamber; a mounting table installed in the processing chamber and configured to mount a substrate; and an upper electrode that is positioned above the mounting table to face toward the mounting table within the processing chamber, the cleaning method comprising:
introducing a cleaning gas into the processing chamber when the substrate is not mounted on the mounting table, the cleaning gas containing an oxygen gas and a nitrogen gas and having a ratio of a nitrogen gas flow rate to a sum of an oxygen gas flow rate and the nitrogen gas flow rate (nitrogen gas flow rate/(nitrogen gas flow rate+oxygen gas flow rate)) in a range from about 0.05 to about 0.5; and
cleaning the inside of the processing chamber by applying a high frequency power between the mounting table and the upper electrode and exciting the cleaning gas into plasma.

2. The cleaning method of claim 1, wherein the ratio of the nitrogen gas flow rate to the sum of the oxygen gas flow rate and the nitrogen gas flow rate in the cleaning gas (nitrogen gas flow rate/(nitrogen gas flow rate+oxygen gas flow rate)) is in a range from about 0.2 to about 0.4.

3. The cleaning method of claim 1, wherein the sum of the oxygen gas flow rate and the nitrogen gas flow rate in the cleaning gas is in a range from about 100 to about 800 sccm.

4. The cleaning method of claim 2, wherein the sum of the oxygen gas flow rate and the nitrogen gas flow rate in the cleaning gas is in a range from about 100 to about 800 sccm.

5. The cleaning method of claim 1, wherein the high frequency power is applied to the upper electrode but not to the mounting table.

6. The cleaning method of claim 2, wherein the high frequency power is applied to the upper electrode but not to the mounting table.

7. The cleaning method of claim 3, wherein the high frequency power is applied to the upper electrode but not to the mounting table.

8. The cleaning method of claim 4, wherein the high frequency power is applied to the upper electrode but not to the mounting table.

9. A storage medium storing therein a program for controlling a plasma processing apparatus including: a processing chamber; a mounting table installed in the processing chamber and configured to mount a substrate; and an upper electrode that is positioned above the mounting table to face toward the mounting table within the processing chamber,
wherein the program is executed to:
introduce a cleaning gas into the processing chamber when the substrate is not mounted on the mounting table, the cleaning gas containing an oxygen gas and a nitrogen gas and having a ratio of a nitrogen gas flow rate to a sum of an oxygen gas flow rate and the nitrogen gas flow rate (nitrogen gas flow rate/(nitrogen gas flow rate+oxygen gas flow rate)) in a range from about 0.05 to about 0.5; and
clean the inside of the processing chamber by applying a high frequency power between the mounting table and the upper electrode and exciting the cleaning gas into plasma.
